(19) United States
(12) Patent Application Publication
(10) Pub. No.: US 2011/0231438 A1
(43) Pub. Date: Sep. 22, 2011

(54) Infotainment System And Computer Program Product

(75) Inventors: Martin Pfeifle, Seewald (DE); Kurt Stege, Regensburg (DE)

(73) Assignee: Continental Automotive GmbH

(21) Appl. No.: 13/119,874

(22) PCT Filed: Sep. 10, 2009
(86) PCT No.: PCT/EP09/61747

§ 371 Date: Jun. 13, 2011

(30) Foreign Application Priority Data
Sep. 19, 2008 (DE) 10 2008 047 915.2

(51) Int. Cl. G06F 17/30

(52) U.S. Cl. 707/769; 707/705; 707/E17.014

(57) ABSTRACT

An infotainment system including a relational database stored on a memory medium, and a database management system. The database management system is designed to access infotainment data stored in the relational database as data records. A data record includes a clear characteristic of the data record and at least one table property. At least the clear characteristic of the respective data record is stored in a property value table in the relational database. The property value table represents a corresponding value of the table property of the respective data record.

### PRIORITY CLAIM

This is a U.S. national stage of Application No. PCT/EP2009/061747, filed on Sep. 10, 2009, which claims priority to German Application No: 10 2008 047 915.2, filed: Sep. 19, 2008, the contents of which are incorporated herein by reference.

### BACKGROUND OF THE INVENTION

1. Field of the Invention

The invention relates to an infotainment system and to a computer program product for operating the infotainment system.

2. Related Art

Infotainment systems are, for example, installed in modern motor vehicles for the conveyance of information, for example navigation data, and of entertainment data, for example TV data or music data. These infotainment data is preferably stored and managed by a database system.

A modern database system generally comprises a database and a database management system. The data is stored in the database. The database management system is provided for managing the data in the database. The management of the database can, for example, comprise searching, reading and/or writing data in the database. In particular, data that is no longer up to date is updated by an updating command that comprises a combination of search commands, read commands, and/or write commands.

### SUMMARY OF THE INVENTION

An object of one embodiment of the invention is to provide an infotainment system and a computer program product for operating the infotainment system that permits the efficient storage of infotainment data.

A first aspect of the invention is defined by an infotainment system that comprises a relational database, which is stored on a storage medium, and a database management system. The database management system is designed to access infotainment data stored as data records in the relational database. A data record has a uniquely defined identifier of the data record and at least one table property. At least the uniquely defined identifier of the respective data record is stored in a property value table in the relational database. The property value table represents a corresponding value of the table property of the respective data record. This permits particularly efficient storage of the infotainment data in the relational database, in particular by virtue of the fact that the at least one table property is not stored in the respective property value table but is instead represented by the respective property value table itself. The relational database and the database management system can, for example, be integrated as one functional unit in the infotainment system. However, it is basically also possible for the relational database and the database management system to be assigned as separate functional units to the infotainment system. The infotainment system is preferably embodied as a computer system. With respect to the spatial arrangement of the data of the respective property value table, said data is preferably stored in a coherent fashion on the storage medium.

In one embodiment of the invention the respective data record has the uniquely defined identifier of the data record and the at least one table property and at least one further property. In this context, the uniquely defined identifier and the at least one further property of the respective data record are stored in the property value table. The at least one further property can be embodied, for example, as at least one data packet, for example a BLOB (Binary Large Object). The at least one further property is preferably embodied as a data record attribute.

In a further advantageous refinement of the first aspect, table data records of at least one meta data table are stored in the relational database. By the meta data table, the corresponding property value table can be referenced as a function of the corresponding value of the at least one table property of the respective data record. The at least one meta data table is preferably stored separately in the relational database. Preferably all the property value tables stored in the relational database can be determined as a function of the meta data table. Basically, it is also possible to determine the associated property value table as a function of the value of the table property assigned to the respective data record, wherein the value can, for example, be predefined by an instruction. Depending on the same instruction or, for example, a further instruction, it is then possible to access the at least one further property and therefore the infotainment data in a reading and/or writing fashion. This permits particularly rapid access to the infotainment data and at the same time permits particularly efficient storage of the infotainment data.

In one embodiment, the database management system is designed to access the corresponding property value table as a function of at least one predefined instruction, and to reconstruct the corresponding data record with the at least one table property represented by the property value table. In this context, the database management system is also designed to access a table property and/or the at least one further property of the reconstructed data record as a function of the at least one predefined instruction. By the property value table, the corresponding data record can be particularly easily reconstructed, in particular by the use of SQL as a predefined instruction. However, it is basically also possible to use proprietary instructions for the reconstruction of the data records.

In one embodiment, the database management system is designed to determine the at least one property value table by the meta data table as a function of the at least one predefined instruction. This permits particularly efficient storage of the infotainment data, since a property value table does not have to be provided for every possible value of the at least one table property. As a result, the meta data table preferably references only the property value tables which represent the values of the at least one table property which are actually used.

In one embodiment, the property value table represents at least one Boolean value and/or at least one value of a predefined value set of the at least one table property. The predefined value set comprises only a predefined number of different values which can be used for the at least one table property. The use of the property value table ensures efficient storage of the data records particularly when there are a limited number of different possible values of the at least one table property.

In a further advantageous refinement of the first aspect, the predefined instruction is embodied as a SQL instruction. This permits particularly rapid reading access and/or writing access to the infotainment data in the relational database.

A second aspect of the invention is defined by a computer program product. The computer program product comprises a computer-readable medium with program instructions. The program instructions can be executed by a computer. In addition, the program instructions are designed to operate the infotainment system according to the first aspect of the invention.

### BRIEF DESCRIPTION OF DRAWINGS

The invention will be explained in more detail below with reference to the drawings, in which:

FIG. 1 is a database system;

FIG. 2 is a first table;

FIG. 3 are a plurality of property value tables for Boolean values;

FIG. 4 are a plurality of property value tables and a meta data table;

FIG. 5 shows a plurality of property value tables for a plurality of Boolean values and a meta data table; and

FIG. 6 is a further meta data table.

Elements of the same design or function are characterized by the same reference symbols in all the figures.

### DETAILED DESCRIPTION OF DRAWINGS

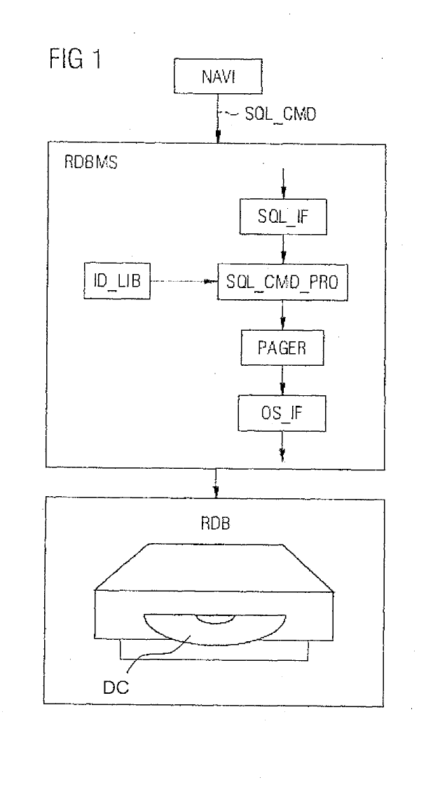

An infotainment system (FIG. 1) comprises an infotainment device INFO, a database management system RDBMS and a relational database RDB. The infotainment system can, for example, comprise a navigation system NAVI and serves to find a predefined route and/or to calculate a predefined distance and/or to find a predefined location and/or to determine further information. However, the infotainment system can additionally or alternatively also comprise a music system and be designed, for example, to find and play predefined pieces of music.

The infotainment device INFO, the relational database RDB and the database management system RDBMS can, for example, be integrated into one technical device, that is arranged, for example, in a motor vehicle. Alternatively, the infotainment device INFO, the relational database RDB and the database management system RDBMS can also be software functional units which are used by the technical device. The technical device can, for example, be an on-board computer of a motor vehicle and/or a computer, for example a portable computer, for example a laptop. The technical device preferably has, apart from at least one output unit, at least one input unit which serves to input information, for example on a route and/or a piece of music, which is to be determined, and/or information on the basis of which infotainment data are changed, in particular updated.

The infotainment device INFO communicates with the database management system RDBMS. The database management system RDBMS comprises an instruction interface SQL_IF, an instruction command process SQL_CMD_PRO, a pager PAGER, a directory ID_LIB of index structures and an operating system interface OS_IF.

The database management system RDBMS communicates with the relational database RDB. The infotainment data, for example navigation data and/or music data, are stored in the relational database RDB.

The infotainment device INFO preferably communicates with the database management system RDBMS in such a way that the infotainment device INFO transmits an instruction SQL_CMD to the database management system RDBMS. Alternatively, the instruction SQL_CMD can also be represented by suitable signals which are then converted into the corresponding instruction SQL_CMD in the database management system RDBMS. The instruction SQL_CMD is preferably embodied as an SQL instruction.

The instruction interface SQL_IF serves to check whether the instruction SQL_CMD is syntactically correct. If the instruction SQL_CMD is syntactically correct, it is transferred from the instruction interface SQL_IF to the instruction command processor SQL_CMD_PRO.

The instruction command processor SQL_CMD_PRO preferably determines a software execution schedule as a function of the instruction SQL_CMD and preferably as a function of at least one available index structure which is stored in the directory ID_LIB of the index structures. The software execution schedule is a program section which serves to configure the access to the infotainment data as efficiently as possible.

The software execution schedule is transferred from the instruction command processor SQL_CMD_PRO to the pager PAGER. The pager PAGER preferably serves to determine a hardware execution schedule as a function of the software execution schedule. The hardware execution schedule is representative of how a piece of hardware, for example a CD-ROM disk drive and/or a hard disk and/or further data carriers which can comprise the relational database RDB have to be actuated in order to work through the software execution schedule.

The hardware execution schedule is transferred to the operating system interface OS_IF which converts the hardware execution schedule into corresponding actuation signals for the technical device on which the infotainment data are stored and/or which comprises the storage medium on which the infotainment data are stored.

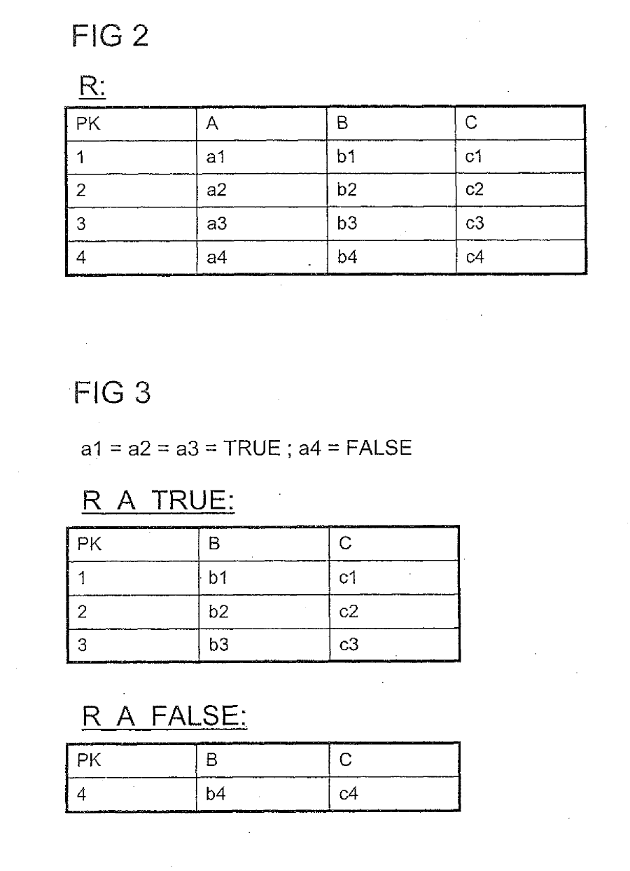

The infotainment data are stored in the relational database RDB as data records in tables. FIG. 2 illustrates an original table R that has a first, second, third and fourth data record. Each data record is assigned a uniquely defined identifier PK and in each case a first, second and third property A, B, C. The respective uniquely defined identifier PK represents the respective data record. For example, the fourth data record with the uniquely defined identifier PK 4 has the first property a4, the second property b4 and the third property c4. The properties of the respective data record are preferably embodied as data record attributes.

In FIG. 3, the values of the first property A of the respective data record are embodied as Boolean values. Therefore, the first, second and third data record a1, a2, and a3 are respectively assigned a Boolean value TRUE, and the fourth data record a4 is assigned a Boolean value FALSE as the first property A. The first property A can also be referred to as a table property of the respective data record.

FIG. 3 illustrates a first and a second property value table R_A_TRUE, R_A_FALSE. The first property value table R_A_TRUE represents the Boolean value TRUE of the first property A. The second property value table R_A_FALSE represents the Boolean value FALSE of the first property A. In this context, the uniquely defined identifier PK, the second and third properties B, C of all the data records of the original table R which have the Boolean value TRUE as the first property A are assigned to the first property value table R_A_TRUE, and the uniquely defined identifier PK, the second and third properties B, C of all the data records of the original table R which have the Boolean value FALSE as the first property A are assigned to the second property value table R_A_FALSE. Since the fourth data record of the original table R is the only data record to have the value FALSE as a first property A, only the uniquely defined identifier PK and properties B, C thereof are assigned to the second property value table R_A_FALSE. The uniquely defined identifier PK and the properties B, C of the other data records of the original table are assigned to the first property value table R_A_TRUE. The value of the respective first property A is represented by the assigned property value table R_A_TRUE, R_A_FALSE. It is basically also possible for just the respective uniquely defined identifiers PK to be assigned to the respective property value tables R_A_TRUE, R_A_FALSE.

Typically, apart from the storage of the actual values of the respective properties, additional meta data is preferably also reserved for each property, for example one or two bytes of meta data, in the relational database RDB. For example, the respective Boolean value of the first property A not only has one bit, which would be sufficient for a value TRUE or FALSE, but also additional bytes for the additional meta data. In addition, indices of properties in the data records are frequently stored in the directory ID_LIB of the index structures in the database management system RDBMS in which indices preferably permit direct, and therefore particularly rapid, access to the respective properties. Through the use of the property value tables R_A_TRUE, R_A_FALSE it is possible for this additional storage requirement for the additional meta data of the at least one table property on the storage medium DC and for the respective indices of the at least one table property in the directory ID_LIB of the index structures to be saved, which permits, in particular in the case of a high number of data records, that is to say for example a million or more, a particularly reduced storage requirement in the relational database RDB and the database management system RDBMS. In addition, the low storage requirement also reduces the access time of the database management system RDBMS to the relational database RDB, and therefore ensures particularly rapid access to the infotainment data.

The original table R (FIG. 2) can be particularly easily reconstructed using the first and second property value table R_A_TRUE, R_A_FALSE. It is therefore possible to reconstruct, for example by the instruction SQL_CMD:

```
create view R as
  select PK, TRUE, B, C FROM R_A_TRUE union
  select PK, FALSE, B, C FROM R_A_FALSE
```

the original table R (FIG. 2). In this context, the values TRUE and FALSE in the first and second select sub-instructions respectively represent constant values which are predefined as values of the respective first property A for the reconstruction of the original table R.

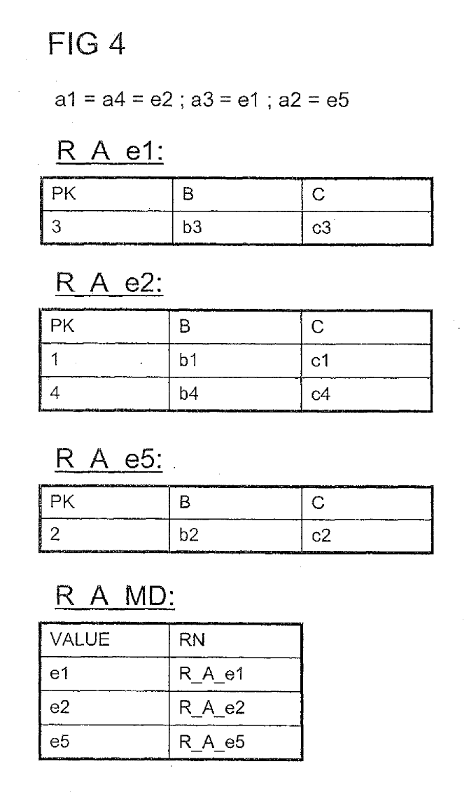

In FIG. 4, the respective first property A assumes a value of a predefined value set that comprises, for example, the different values e1, e2, e3, e4, or e5. For example, the first property A of the first and fourth data records has the value e2. The first property A of the third data record has the value e1, and that of the second data record has the value e5. The values e3 and e4 are unused. The uniquely defined identifier PK and the second and third properties B, C of the four data records of the original table R are stored in a first, second and third property value table R_A_e1, R_A_e2, R_A_e5 in the relational database ROB. Therefore, the uniquely defined identifier PK and the properties B, C of the first and fourth data records of the original table R are assigned to the second property value table R_A_e2, while the uniquely defined identifier PK and the properties B, C of the third data record are assigned to the original table R of the first property value table R_A_e1, and the uniquely defined identifier PK and the properties B, C of the second data record are assigned to the third property value table R_A_e5. In addition, a meta data table R_A_MD is represented which is stored in the relational database RDB together with the property value tables R_A_e1, R_A_e2, R_A_e5. By the meta data table R_A_MD it is possible to reference the respective property value table directly as a function of the predefined value of the first property A. If, for example during a reading access by the instruction SQL_CMD, a value e2 is predefined as a table property A, the property value table R_A_e2 can be referenced directly using the meta data table R_A_MD and the respective second and third properties B, C can then be accessed, for example by a further instruction SQL_CMD. This has the advantage that there is no need to store a respective property value table for the unused values e3, e4 of the predefined value set. This also brings about a reduced storage requirement since meta data is also assigned to every empty table stored in the relational database RDB, and said data can be saved through the use of the meta data table.

In particular in the case of infotainment data that is embodied as navigation data, it is frequently the case that said data has to be updated or changed, for example owing to changed routing of roads. It is perfectly possible that the at least one table property of the respective data record is also changed. In this context, the database management system RDBMS is designed to copy over the further properties of the corresponding data record into another property value table or to initially generate a newly assigned property value table and then to copy over the further properties of the corresponding data record and then adapt the corresponding meta data table, as a function of the at least one predefined instruction SQL_CMD.

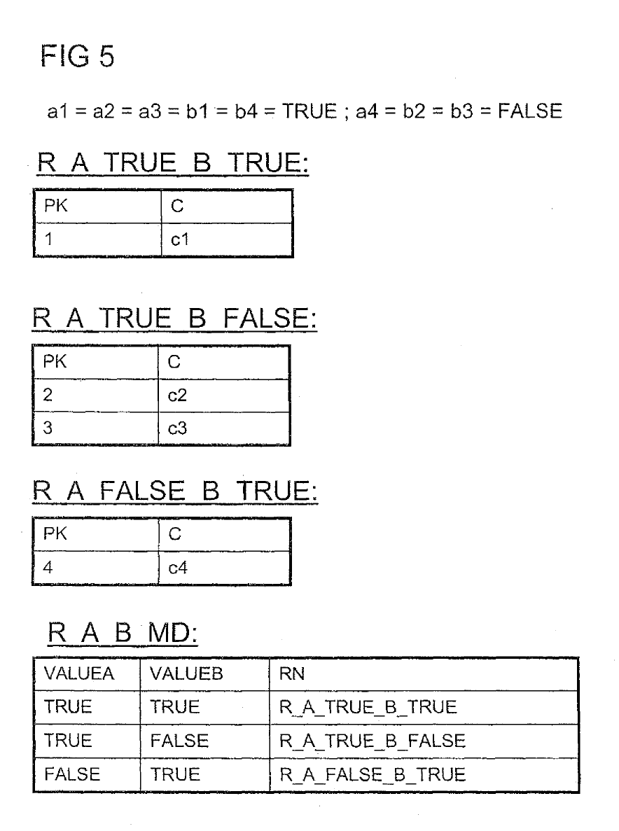

In FIG. 5, the first property A is used as a first table property A, and the second property B is used as a second table property B. The first and the second table properties A, B each assume Boolean values. This results in four possible combinations of the first and second table properties A, B. If, for example, the second data record of the original table R is assigned a value TRUE as a first property A, and a value FALSE as a second property B, only the uniquely defined identifier PK and the third property C of the second data record are still assigned to the property value table R_A_TRUE_B_FALSE, which is representative of the value of the first and second properties A, B of the second data record. In addition, a further meta data table R_A_B_MD is stored in the relational database RDB references the respective property value table as a function of the values of the first and second properties A, B. Owing to the use of the further meta data table R_A_B_MD, a further property value table that represents the unused value FALSE of the first property A and the value FALSE of the second property B, is not necessary. By using the further meta data table R_A_B_MD, it is therefore initially possible to determine all the stored property value tables by, for example, a first instruction:

select VALUEA, VALUEB, RN from R_A_B_MD

After this, the original table R (FIG. 2) can be reconstructed as a function of the result of the determination of the first instruction by a further instruction

```
create view R as
  select PK, TRUE, TRUE, C FROM R_A_TRUE_B_TRUE union
  select PK, TRUE, FALSE, C FROM R_A_TRUE_B_FALSE union
  select PK, FALSE, TRUE, C FROM R_A_FALSE_B_TRUE
```

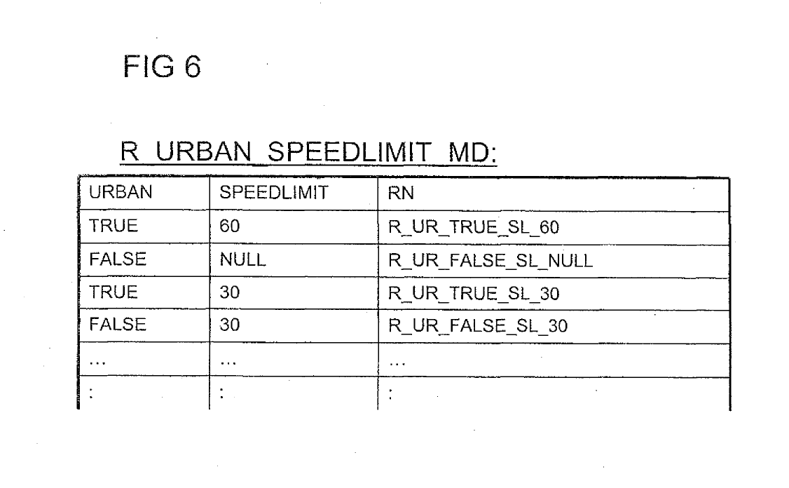

FIG. 6 illustrates a locality meta data table R_URBAN_SPEEDLIMIT_MD that can be used in conjunction with the navigation system of the infotainment system. In this context, a respective locality property value table R_UR_TRUE_SL_60, R_UR_FALSE_SL_30, R_UR_TRUE_SL_30, R_UR_FALSE_SL_30 (which is not illustrated) is referenced as a function of a first locality table property URBAN and a second locality table property SPEEDLIMIT. In this context, the first locality table property URBAN has Boolean values and therefore represents whether or not a current position of the motor vehicle, which has been determined by the navigation system, is in an urban area. The second locality table property SPEEDLIMIT can preferably assume different integral values and the value ZERO, and therefore represents a speed limit assigned to the determined current position of the motor vehicle. The value ZERO of the second locality table property SPEEDLIMIT represents a non-speed limit at the determined position of the motor vehicle. The second locality table property SPEEDLIMIT preferably only assumes predefined integral values, for example 30, 50, 60, 70, 80, 90, 100, 120, with the result that only a limited number of combinations of the first and second locality table properties URBAN, SPEEDLIMIT are used as possible combinations. As a result, the locality property tables are only created for integral values of the second locality table property SPEEDLIMIT which are used. In addition, it is necessary to take into account the fact that some properties preferably cannot be combined, for example a speed limit of 120 km/h in the urban area. For example, a current position in the urban area is assigned to the determined current position of the motor vehicle by a value TRUE of the first locality table property URBAN. A permissible maximum speed of 60 km/h for the current position of the motor vehicle is assigned to this first locality table property URBAN by, for example, a value 60 of the second locality table property SPEEDLIMIT. These first and second locality table properties URBAN, SPEEDLIMIT are assigned a locality property value table R_UR_TRUE_SL_60 in which further properties are stored.

The data of the respective property value tables and those of the respective meta data tables are preferably stored in a coherent fashion with respect to their arrangement on the storage medium DC of the relational database RDB. In this context, the data of the respective property value tables and those of the respective meta data tables are stored in a coherent fashion in different storage areas on the storage medium DC.

Basically, it is also possible to use more than two properties of a table as table properties, wherein the values of each table property can be embodied as a Boolean value or as an integral value or as a value of the predefined value set or as another value of a possible data type. When a plurality of table properties are used, any desired combination of different data types of the values of the respective table properties is also possible. It is also possible to store a plurality of meta data tables in the relational database RDB and to reference a plurality of different property value tables.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. An infotainment system comprising:
a relational database stored on a nontransient storage medium; and
a database management system configured to access infotainment data stored as a data record in the relational database,
wherein the data record has a uniquely defined identifier and at least one table property, the uniquely defined identifier of the data record is stored in a property value table in the relational database that represents a corresponding value of the table property of the data record.

10. The infotainment system as claimed in claim 9, wherein the respective data record has the uniquely defined identifier of the data record and the at least one table property and at least one further property, wherein the uniquely defined identifier and the at least one further property of the respective data record are stored in the property value table.

11. The infotainment system as claimed in claim 9, wherein table data records of at least one meta data table are stored in the relational database, by said meta data table the property value table can be referenced as a function of the corresponding value of the at least one table property of the data record.

12. The infotainment system as claimed in claim 9, wherein the database management system is configured to:
access the property value table as a function of at least one predefined instruction,
reconstruct the corresponding data record with the at least one table property represented by the property value table, and
access at least one of the at least one table property and at least one further property of the reconstructed data record as a function of at least one predefined instruction.

13. The infotainment system as claimed in claim 11, wherein the database management system is configured to determine the at least one property value table by the meta data table as a function of at least one predefined instruction.

14. The infotainment system as claimed in claim 9, wherein the property value table represents at least one of at least one Boolean value and at least one value of a predefined value set of the at least one table property.

15. The infotainment system as claimed in claim 12, wherein the predefined instruction is an SQL instruction.

16. A computer program product that comprises a nontransient computer-readable medium with program instructions that can be executed by a computer and which are configured to operate an infotainment system that comprises:
a relational database stored on the non transient computer readable storage medium, and
a database management system configured to access infotainment data stored as a data record in the relational database,
wherein the data record has a uniquely defined identifier and at least one table property, the uniquely defined identifier of the data record is stored in a property value table in the relational database that represents a corresponding value of the table property of the data record.

17. The infotainment system as claimed in claim 10, wherein table data records of at least one meta data table are stored in the relational database, by which meta data table the property value table can be referenced as a function of the corresponding value of the at least one table property of the data record.
